(19) United States
(12) Patent Application Publication
(10) Pub. No.: US 2005/0193636 A1
(43) Pub. Date: Sep. 8, 2005

(54) Thermoplastic vehicle weather stripping

(76) Inventors: Sam M. Jyawook, Ann Arbor, MI (US); Shawn J. Jyawook, Ann Arbor, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/058,101

(22) Filed: Feb. 15, 2005

Related U.S. Application Data
(63) Continuation of application No. 10/077,427, filed on Feb. 15, 2002, now abandoned.

(51) Int. Cl. E06B 1/70

(52) U.S. Cl. 49/498.1

(57) ABSTRACT

Weather stripping for use in sealing an interface between selected vehicle portions is made using a thermoplastic material such as TPV with a supercritical fluid introduced during the manufacturing process to provide a microcellular structure. The microcellular structure of one example implementation of this invention includes a cell density in a range from about 10⁹ to about 10¹⁵ per cubic centimeter. Average cell sizes preferably are less than 2 microns. A preferred range in one example is between about 0.1 micron and about 1.0 micron. The inventive design provides superior performance with cost savings compared to rubber weather stripping.

### BACKGROUND OF THE INVENTION

This invention generally relates to weather stripping for vehicles. More particularly, this invention relates to weather stripping comprising a thermoplastic material that is useful for providing a seal along portions of vehicle body parts.

Typical modern day vehicles include various body panels that collectively establish an exterior of the vehicle. There are a wide variety of vehicle styles and many part configurations within each style. Most vehicles includes portions like doors and hatches that must be moveable relative to other portions to provide access to the vehicle, for example. Similarly, most vehicles includes windows that are selectively moveable between open and closed positions.

It is necessary to adequately seal off interfaces between moveable and stationary parts of the vehicle body. An adequate seal insures that environmental elements, like rain for example, do not undesirably enter the interior of the vehicle or otherwise contact portions of the vehicle that need shielding from such elements. A variety of weather stripping configurations have been used to accomplish this function.

Another useful feature of weather stripping for vehicles is that it can enhance the quality of the vehicle owner's enjoyment or comfort while driving. For example, an adequate seal along an interface between a vehicle door and the adjacent body structure not only keeps out rain but, if adequately designed, may reduce or eliminate noise propagation into the vehicle interior. Reducing so-called wind noise is currently regarded as an important feature in providing a quality automobile.

Conventional weather stripping is made from rubber. While rubber has proven useful, it is not without drawbacks. One shortcoming of rubber weather stripping is that it tends to wear or become hardened over time so that the quality of the seal eventually degrades. Another issue associated with using rubber is that it is more expensive, which tends to keep the cost of the product up. In the automotive industry cost savings are a premium consideration and rubber weather stripping does not provide as much savings as is desirable. There are additional issues with processing and handling waste when using rubber that tend to be drawbacks.

While there have been proposals to blend rubber with other materials, there has not been wide industry acceptance of such products and the associated costs have not proven beneficial enough to replace rubber weather stripping with such a substitute.

There is a need for an improved weather stripping that is useful for vehicles. This invention addresses that need, introduces cost savings, provides a superior product and avoids the shortcomings and drawbacks of the prior art.

### SUMMARY OF THE INVENTION

In general terms, this invention is weather stripping comprising a thermoplastic material having a microcellular composition.

In one example, the inventive weather stripping comprises a thermoplastic vulcanizate (TPV).

The microcellular structure of one example implementation of this invention includes a cell density in a range from about 10⁹ to about 10¹⁵ per cubic centimeter with average cell sizes between 0.1 micron and about 1.0 micron.

The inventive arrangement provides a superior product that is lighter in weight, stronger and less expensive than prior designs. Additionally, the inventive arrangement provides a better seal that reduces wind noise at interface locations such as door closures where the inventive seal is placed.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 diagrammatically illustrates, in perspective view, an example weather stripping designed according to this invention.

FIG. 2 schematically illustrates an example process for making weather stripping designed according to this invention.

FIG. 3 schematically illustrates a material process that occurs while making an example weather stripping designed according to this invention.

### DETAILED DESCRIPTION OF THE PREFERRED EMBODIMENTS

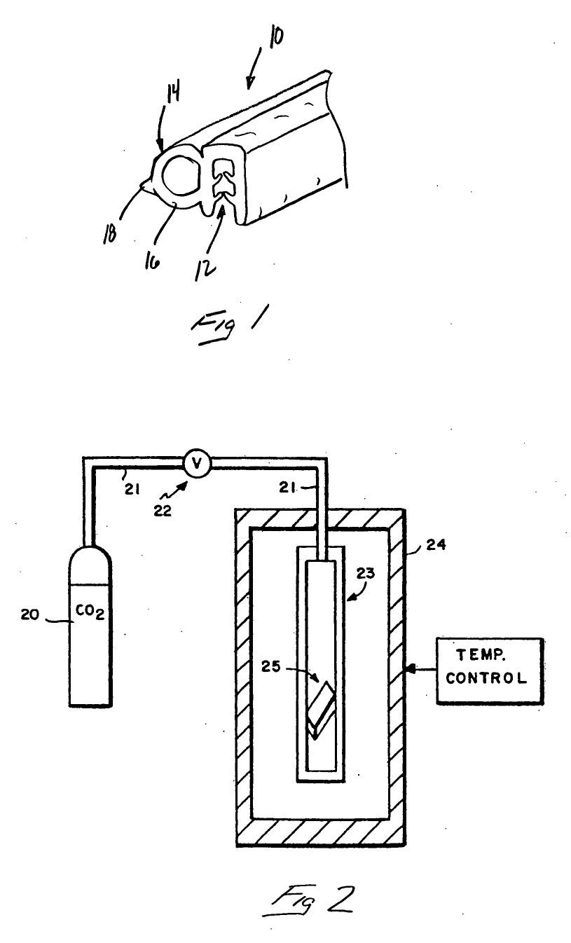

Referring initially to FIG. 1 an example weather stripping 10 designed according to this invention includes a body portion 12 that is adapted to be mounted on a corresponding structure of the vehicle so that the weather stripping is maintained in place as desired. A variety of weather stripping configurations come within the scope of this invention. The illustrated example in no way limits the scope of this invention. In fact, with the inventive approach, a wider variety of weather stripping configurations are possible.

At least one sealing portion 14 is capable of sealing an interface between adjacent vehicle portions, such as two body panels or a window and a doorframe for example. The illustrated example includes a sealing portion 14 having a closed loop 16 with an extending lip 18.

Advantageously, with the inventive arrangement the cross section of the closed loop 16 or the size of the lip 18 can be selectively varied along the length of the weather stripping 10. This was not possible with prior weather stripping designs.

Such customization is possible because of the unique material chosen for the weather stripping 10.

Weather stripping designed according to this invention comprises a thermoplastic material. In one preferred example, the thermoplastic material is a thermoplastic vulcanizate (TPV). Such materials are known and commercially available in a form that is suitable to be processed and extruded into the desired shape of the weather stripping needed for a particular application.

The preferred arrangement includes a microcellular structure which results from using a supercritical fluid during the process of making the weather stripping. In one example, the foam has a closed cell microcellular structure. the size of the cells can be selectively controlled. The microcellular structure of one example implementation of this invention includes a cell density in a range from about 10⁹ to about 10¹⁵ per cubic centimeter. Average cell sizes preferably are less than 2 microns. A preferred range in one example is between about 0.1 micron and about 1.0 micron. The microcellular structure provides a better seal compared to previous designs because there is an increased contact area provided by the inventive weather stripping.

There are known methods for processing TPV. One example process is disclosed in U.S. Pat. No. 5,334,356. The teachings of that patent are incorporated into this specification by reference.

For purposes of this discussion, a supercritical fluid can be defined as a material which is maintained at a temperature which exceeds a critical temperature and at a pressure which exceeds a critical pressure so as to place the material in a supercritical fluid state. In such state, the supercritical fluid has properties that cause the material to act, in effect, as a gas and a liquid. Thus, in the supercritical state, such a fluid has the solvent characteristics of a liquid, but its surface tension is substantially less than that of a liquid so that the fluid can diffuse much more readily into a solute material, as in the nature of a gas. For example, it is known that carbon dioxide can be placed in a supercritical state when its temperature exceeds 31 degrees C.

The currently preferred process for making the inventive weather stripping includes using one of CO₂, nitrogen or a mixture of both.

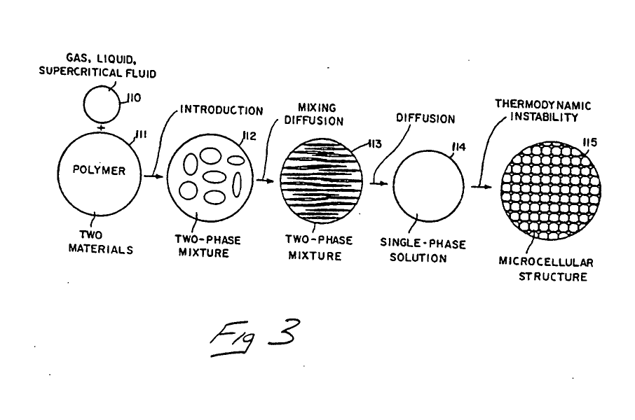

FIG. 2 schematically shows one example system for use in forming supercritical foamed thermoplastic materials to make weather stripping in accordance with the invention. A source of carbon dioxide or nitrogen or both in a non-critical state is provided from a pressurized cylinder 20 in which the selected fluid is maintained at a pressure and temperature below the known critical values for that fluid. A conduit 21 and a high-pressure valve 22 supply the supercritical fluid to a high pressure chamber 23. The temperature of the chamber can be controlled, for example, by placing the chamber in a temperature controlled enclosure 24. A material 25, such as TPV, is placed within the chamber 23. The temperature of the chamber is controlled to be set at a selected initial temperature level.

The supercritical fluid is introduced into the TPV material 25 according to known techniques to achieve a foamed material having a microcellular structure. A closed cell foam is preferred for at least some example weather stripping. This structure for the weather stripping provides several advantages over rubber or other materials previously used to make weather stripping. Further details of one example forming process can be found in U.S. Pat. No. 5,334,356 or U.S. Pat. No. 6,051,174. The teachings of the latter are also incorporated into this specification by reference.

FIG. 3 schematically shows the morphological changes of a foaming agent and a polymer material that occur in an example process of making weather stripping according to this invention. Initially, a foaming agent 110, which can be a gas or other supercritical fluid, and a polymer 111 are separate materials. A metered amount of foaming agent 110 is then introduced into a molten stream of polymer to form a two-phase polymer/agent mixture 112 having a substantially constant weight ratio of the materials. The injected agent bubbles are broken into smaller bubbles and subsequently stretched or elongated during a further mixing process to form a desired two-phase mixture 113 in which the agent may be partially diffused in the mixture, for example. The agent is then more fully diffused into the polymer matrix, forming a single-phase solution 114.

Alternatively, all of the diffusion of the agent into the polymer can occur after the mixing stage or all of the diffusion can occur during the mixing stage in which case no further diffusion is needed.

A thermodynamic instability is induced in the polymer/agent solution to promote microcellular nucleation to form a microcellular structure 115. The formation of the polymer/agent mixture, the completion of the single-phase solution formation, and the microcellular nucleation are three critical steps for the manufacture of such microcellular (or supermicrocellular) polymers. Such steps are integrated into a continuous extrusion process so that the known required functions are satisfied.

The machinery used to make the inventive weather stripping comprises known components, examples of which are discussed in U.S. Pat. No. 6,051,174.

The inventive arrangement provides weather stripping having superior sealing qualities compared to previous designs. The microcellular structure of the inventive weather stripping increases the contact area. The inventive weather stripping reduces noise. The inventive arrangement provides foams with stiffness loss that is linear to density reduction. The preferred TPV provides lower friction parts that resist wear while providing sealing properties available using a thermo set rubber. The homogenous, microcellular structure of the inventive arrangement allows the inventive weather stripping to be lighter weight yet stronger than other designs. There is a significant reduction in material mass and cost associated with the inventive design. Another economy achieved with this invention is that a separate coating is not necessary (although one could be used), which provides additional cost savings. Moreover, the inventive approach provides a wider variety of designs than were previously possible with lower associated costs. For example, unique cross-sectional configurations that vary along the length of the weather stripping are achievable.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A weather stripping for use in sealing an interface between selected portions of a vehicle, comprising:
a body portion that is adapted to be supported on a selected one of the vehicle portions; and
a sealing portion extending at least partially away from the body portion, the sealing portion and the body portion comprising a thermoplastic material with at least the sealing portion having a microcellular structure.

2. The weather stripping of claim 1, wherein the thermoplastic material comprises TPV.

3. The weather stripping of claim 2, wherein at least the thermoplastic material of the sealing portion is foamed.

4. The weather stripping of claim 1, wherein the microcellular structure includes cells having a size less than about 2 microns.

5. The weather stripping of claim 4, wherein the microcellular structure includes cells having a size between about 0.1 micron and about 1.0 micron.

6. The weather stripping of claim 1, wherein the thermoplastic material has a microcellular structure with a cell density in the range from about 10⁹ to about 10¹⁵ per cubic centimeter.

7. The weather stripping of claim 1, wherein at least one of the body portion or the sealing portion has a cross sectional dimension that selectively varies along a length of the weather stripping.

8. A method of making weather stripping for use in sealing an interface between selected portions of a vehicle, comprising the steps of:
melting a thermoplastic material;
introducing a supercritical fluid into the melted thermoplastic material;
forming a microcellular structure in the thermoplastic material using the supercritical fluid; and
forming the weather stripping from the thermoplastic material having the microcellular structure.

9. The method of claim 8, wherein the weather stripping has a sealing portion that has a cross section and including varying the cross section along selected portions of the length of the sealing portion.

10. The method of claim 8, wherein the thermoplastic material comprises TPV.

11. The method of claim 8, including forming the microcellular structure such that the thermoplastic material is a close cell foam.

12. The method of claim 8, including forming the microcellular structure such that the cells have a size less than about 2 microns.

13. The method of claim 12, including forming the microcellular structure such that the cells have a size between about 0.1 micron and about 1.0 micron.

14. The method of claim 8, including forming the microcellular structure such that the material has a cell density in the range from about 10⁹ to about 10¹⁵ per cubic centimeter.

15. A weather stripping for use in sealing an interface between selected portions of a vehicle, the weather stripping having a body portion that is adapted to be supported on a selected one of the vehicle portions and a sealing portion extending at least partially away from the body portion, made by the process comprising the steps of:
melting a thermoplastic material;
introducing a supercritical fluid into the melted thermoplastic material;
forming a microcellular structure in the thermoplastic material using the supercritical fluid; and
forming the weather stripping from the thermoplastic material having the microcellular structure.

16. The weather stripping of claim 15, wherein the thermoplastic material comprises TPV.

17. The weather stripping of claim 15, wherein the microcellular structure includes cells having a size less than about 2 microns.

18. The weather stripping of claim 17, wherein the microcellular structure includes cells having a size between about 0.1 micron and about 1.0 micron.

19. The weather stripping of claim 15, wherein the thermoplastic material has a cell density in the range from about 109 to about 1015 per cubic centimeter.

20. The weather stripping of claim 15, wherein at least one of the body portion or the sealing portion has a cross sectional dimension that selectively varies along a length of the weather stripping.
